(19) United States
(12) Patent Application Publication
(10) Pub. No.: US 2026/0229117 A1
(43) Pub. Date: Aug. 6, 2026

(54) EMERGENCY VEHICLE ALERT DEVICE

(71) Applicant: Richard Kupelian, Bellevue, TN (US)

(72) Inventor: Richard Kupelian, Bellevue, TN (US)

(21) Appl. No.: 19/046,858

(22) Filed: Feb. 6, 2025

(51) Int. Cl. G08G 1/0965; H04W 4/029; H04W 4/40; H04W 4/90

(52) U.S. Cl. CPC G08G 1/0965; H04W 4/029; H04W 4/40; H04W 4/90

(57) ABSTRACT

An emergency vehicle alert device includes a communication network. An emergency dispatch receives an emergency notification of an emergency from the communication network regarding an emergency at a residence or a building. The emergency dispatch broadcasts an emergency alert to the communication network which includes a physical location related to the emergency notification of the emergency. An emergency station receives the emergency alert from communication network. A emergency vehicle receives a response command from the emergency station and a plurality of vehicles travels on a public roadway A plurality of communication devices is each located within a respective vehicle. Each communication device broadcasts a notification alert to inform a driver of a respective vehicle to pull over such that the emergency vehicle can travel unimpeded to the physical location related to the emergency notification of the emergency.

### (b) CROSS-REFERENCE TO RELATED APPLICATIONS

Not Applicable

### (c) STATEMENT REGARDING FEDERALLY SPONSORED RESEARCH OR

### DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to emergency alert devices and more particularly pertains to a new emergency alert device for alerting motorists to the impending presence of an emergency vehicle. The device includes an emergency dispatch and an emergency station and an emergency vehicle located at the emergency station. The device includes a communication network and a global positioning system and a plurality of vehicles which drive on public roadways. The device includes a plurality of communication devices which are each positioned within a respective vehicle. The communication devices are in communication with the global positioning system to determine if the respective vehicle is traveling on the route that the emergency vehicle is taking to travel to an emergency to alert a driver of the respective vehicle to pull over.

### (2) Description of Related Art including information disclosed under 37 CFR 1.97 and 1.98

The prior art relates to emergency alert devices including a variety of emergency vehicle alert devices that each at least includes an emergency vehicle that broadcasts an alert signal to vehicles to alert the vehicles to pull over to allow the emergency vehicle to travel unimpeded to an emergency. In no instance does the prior art disclose an emergency vehicle alert device that includes an emergency dispatch and an emergency station and an emergency vehicle which are each in communication with a communication network and a plurality of vehicles and a plurality of communication devices located in a respective vehicle and a global positioning system to enable the communication devices in each vehicle to determine if the vehicle is located on the route that the emergency vehicle will be taking.

### (h) BRIEF SUMMARY OF THE INVENTION

An embodiment of the disclosure meets the needs presented above by generally comprising a communication network. An emergency dispatch receives an emergency notification of an emergency from the communication network regarding an emergency at a residence or a building. The emergency dispatch broadcasts an emergency alert to the communication network which includes a physical location related to the emergency notification of the emergency. An emergency station receives the emergency alert from communication network. An emergency vehicle receives a response command from the emergency station and a plurality of vehicles travels on a public roadway A plurality of communication devices is each located within a respective vehicle. Each communication device broadcasts a notification alert to inform a driver of a respective vehicle to pull over such that the emergency vehicle can travel unimpeded to the physical location related to the emergency notification of the emergency.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an emergency vehicle alert device according to an embodiment of the disclosure.

FIG. 2 is a schematic view of an embodiment of the disclosure.

FIG. 3 is an interior view of a vehicle of an embodiment of the disclosure.

### (j) DETAILED DESCRIPTION OF THE INVENTION

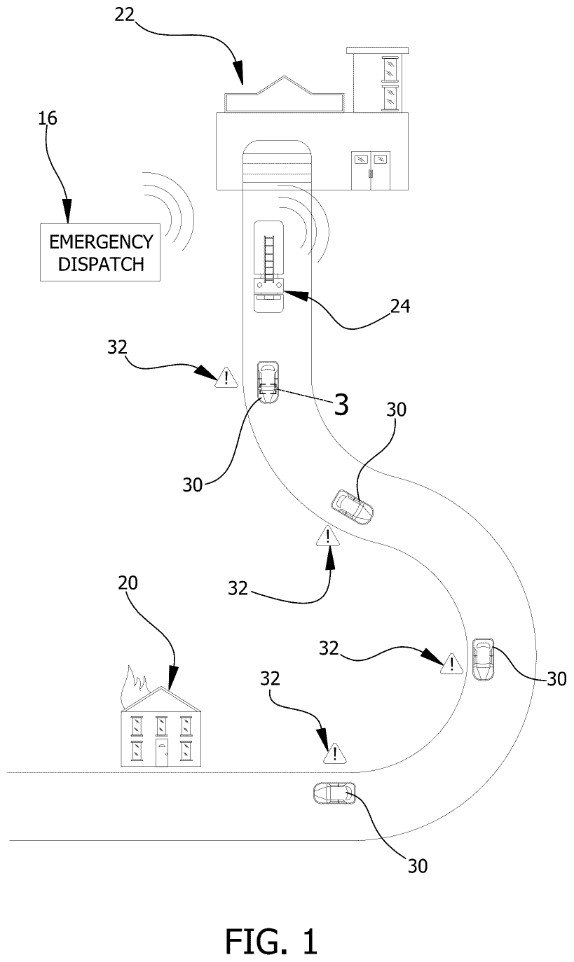

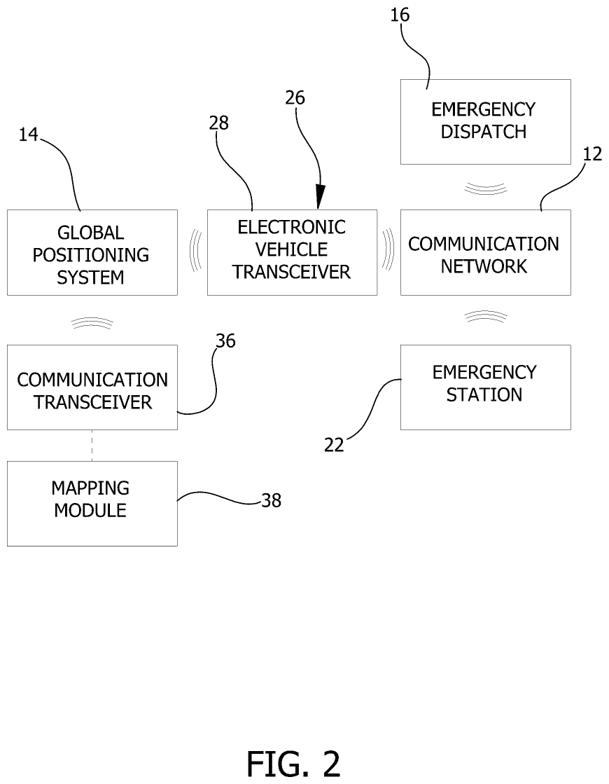

With reference now to the drawings, and in particular to FIGS. 1 through 3 thereof, a new emergency alert device embodying the principles and concepts of an embodiment of the disclosure and generally designated by the reference numeral 10 will be described.

As best illustrated in FIGS. 1 through 3, the emergency vehicle alert device 10 generally comprises a communication network 12 and a global positioning system 14. The communication network 12 may comprise a cellular phone network or the internet or any other type of wireless global communication network. An emergency dispatch 16 is included and the emergency dispatch 16 is in wireless communication with the communication network 12. The emergency dispatch 16 receives an emergency notification of an emergency from the communication network 12.

The emergency dispatch 16 receives a call for help from an occupant of a residence or a building 20 regarding an emergency at the residence of the building 20. Additionally, the emergency dispatch 16 broadcasts an emergency alert to the communication network 12 when the emergency dispatch 16 receives the emergency notification of the emergency from the communication network 12. The emergency alert includes a physical location related to the emergency notification of the emergency and the communication network 12 is extrinsic with respect to the emergency dispatch 16. The emergency dispatch 16 may be a 911 call center or other type of emergency dispatch that is typically employed by local municipalities or townships.

An emergency station 22 is included which is in wireless communication with the communication network 12. The emergency station 22 receives the emergency alert from communication network 12 which was broadcast from the emergency dispatch 16. Additionally, the emergency station 22 broadcasts a response command when the emergency station 22 receives the emergency alert from the communication network 12. The response command includes the physical location related to the emergency notification of the emergency and the communication network 12 is extrinsic with respect to the emergency station 22. The emergency station 22 may be a hospital or a fire station or a police station.

An emergency vehicle 24 is located at the emergency station 22 and the emergency vehicle 24 is in wireless communication with the emergency station 22. The emergency vehicle 24 receives the response command from the emergency station 22 such that the emergency vehicle 24 is notified of the physical location related to the emergency notification of the emergency. Additionally, the emergency vehicle 24 includes a location module 26 which broadcasts a physical location of the emergency vehicle 24 while the emergency vehicle 24 travels to the physical location related to the emergency notification of the emergency. An emergency vehicle transceiver 28 is integrated into the emergency vehicle 24 and the emergency vehicle transceiver 28 defines the location module 26 in the emergency vehicle 24. Furthermore, the emergency vehicle 24 may be an ambulance or a fire engine or a police vehicle.

The emergency vehicle transceiver 28 is in wireless communication with the communication network 12. Furthermore, the emergency vehicle transceiver 28 receives the response command from the communication network 12 such that the emergency vehicle 24 is notified of the physical location related to the emergency notification of the emergency. The emergency vehicle transceiver 28 is in wireless communication with the global positioning system 14 and the emergency vehicle transceiver 28 continuously broadcasts a tracking signal to the global positioning system 14 when the emergency vehicle transceiver 28 receives the response command from the communication network 12. Additionally, the tracking signal comprises a physical location of the emergency vehicle 24 as the emergency vehicle 24 travels to the physical location related to the emergency notification of the emergency. The emergency vehicle transceiver 28 may comprise a radio frequency transceiver or the like which operates on multiple communication frequencies such that the emergency vehicle transceiver 28 can simultaneously communicate with the communication network 12 and the global positioning system 14.

A plurality of vehicles 30 is included and each vehicle 30 of the plurality of vehicles 30 travels on a public roadway. Furthermore, each vehicle 30 of the plurality of vehicles 30 may be a passenger vehicle, a cargo vehicle or any other type of motorized vehicle which commonly travels on public roadways. A plurality of communication devices 32 is provided and each communication device 32 of the plurality of communication devices 32 is located within a respective vehicle 30 of the plurality of vehicles 30. Each communication device 32 of the plurality of communication devices 32 is in wireless communication with the location module 26 in the emergency vehicle 24.

Each communication device 32 of the plurality of communication devices 32 receives the physical location of the emergency vehicle 24 from the location module 26. Additionally, each communication device 32 of the plurality of communication devices 32 broadcasts a notification alert when each communication device 32 of the plurality of communication devices 32 receives the physical location of the emergency vehicle 24 from the location module 26. Furthermore, each communication device 32 of the plurality of communication devices 32 informs a driver 34 of a respective vehicle 30 to pull over such that the emergency vehicle 24 can travel unimpeded to the physical location related to the emergency notification of the emergency.

Each communication device 32 of the plurality of communication devices 32 includes a communication transceiver 36. The communication transceiver 36 in each communication device 32 of the plurality of communication devices 32 is in wireless communication with the global positioning system 14. Additionally, each communication device 32 of the plurality of communication devices 32 establishes a physical location of each communication device 32 of the plurality of communication devices 32 based upon data received from the global positioning system 14. The communication transceiver 36 in each communication device 32 of the plurality of communication devices 32 receives the tracking signal from the global positioning system 14 which was broadcast by the emergency vehicle transceiver 28. The communication transceiver 36 in each communication device 32 of the plurality of communication devices 32 may comprise a radio frequency transceiver or the like.

Each communication device 32 of the plurality of communication devices 32 includes a mapping module 38. The mapping module 38 in a respective communication device 32 of the plurality of communication devices 32 is in electrical communication with the communication transceiver 36 in the respective communication device 32. Furthermore, the mapping module 38 in the respective communication device 32 analyzes the tracking signal from the global positioning system 14 which was broadcast by the emergency vehicle transceiver 28. The mapping module 38 identifies a relationship between the physical location of the respective communication device 32 and the physical location of the emergency vehicle 24. Additionally, the mapping module 38 may comprise navigation software commonly employed for global positioning system navigation assistance in vehicles.

A respective communication device 32 of the plurality of communication devices 32 broadcasts the notification alert when the mapping module 38 determines that the relationship between the physical location of the respective communication device 32 of the plurality of communication devices 32 involves the respective communication device 32 being located on a route is taken by the emergency vehicle 24 as the emergency vehicle 24 travels to the physical location related to the emergency notification of the emergency. Furthermore, the respective communication device 32 informs the driver 34 of a respective vehicle 30 to pull over such that the emergency vehicle 24 can travel unimpeded to the physical location related to the emergency notification of the emergency.

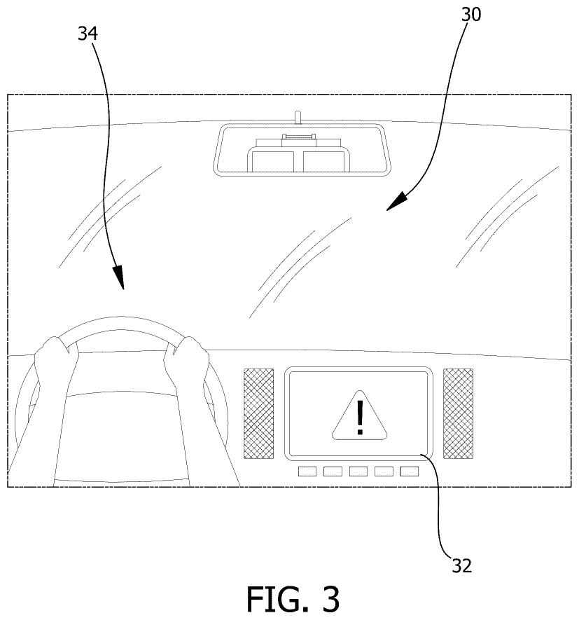

As shown in FIG. 3, each communication device 32 of the plurality of communication devices 32 may comprise an electronic navigation system that is a factory installed component of the respective vehicle 30. Additionally, as is shown in FIG. 3, each communication device 32 of the plurality of communication devices 32 may include an electronic display 40 which displays the notification alert to visually communicate the notification alert to the driver 34. Furthermore, each communication device 32 of the plurality of communication devices 32 may comprise a smart phone, or other similar type of personal electronic device, which is carried by the driver 34 of the vehicle 30.

In use, the emergency dispatch 16 relays the emergency notification to the emergency station 22 and the emergency station 22 relays the emergency notification to the emergency vehicle 24. The emergency vehicle 24 begins to travel to the physical location related to the emergency notification and the emergency vehicle transceiver 28 continuously broadcasts the physical location of the emergency vehicle 24 to the global positioning system 14. Each communication device 32 of the plurality of communication devices 32 receives the physical location of the emergency vehicle 24 from the global positioning system 14. Additionally, a respective communication device 32 of the plurality of communication devices 32 broadcasts the notification alert when the mapping module 38 in the respective communication device 32 determines that the respective communication device 32 is located on the route that the emergency vehicle 24 is taking to travel to the physical location related to the emergency notification. Subsequently, the driver 34 of the vehicle 30 in which the respective communication device 32 is located is informed to pull over to enable the emergency vehicle 24 to travel unimpeded to the physical location related to the emergency notification.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency vehicle alert device for alerting motorists on a route of an emergency vehicle to the impending presence of the emergency vehicle, said device comprising:
a communication network;
an emergency dispatch being in wireless communication with said communication network, said emergency dispatch receiving an emergency notification of an emergency from said communication network wherein said emergency dispatch is configured to receive a call for help from an occupant of a residence or a building regarding an emergency at the residence or the building, said emergency dispatch broadcasting an emergency alert to said communication network when said emergency dispatch receives said emergency notification of said emergency from said communication network, said emergency alert including a physical location related to said emergency notification of said emergency, said communication network being extrinsic with respect to said emergency dispatch;
an emergency station being in wireless communication with said communication network, said emergency station receiving said emergency alert from communication network which was broadcast from said emergency dispatch, said emergency station broadcasting a response command when said emergency station receives said emergency alert from said communication network, said response command including said physical location related to said emergency notification of said emergency, said communication network being extrinsic with respect to said emergency station;
an emergency vehicle being located at said emergency station, said emergency vehicle being in wireless communication with said emergency station, said emergency vehicle receiving said response command from said emergency station such that said emergency vehicle is notified of said physical location related to said emergency notification of said emergency, said emergency vehicle including a location module which broadcasts a physical location of said emergency vehicle while said emergency vehicle travels to said physical location related to said emergency notification of said emergency;
a plurality of vehicles, each vehicle of said plurality of vehicles traveling on a public roadway; and
a plurality of communication devices, each communication device of said plurality of communication devices being located within a respective vehicle of said plurality of vehicles, each communication device of said plurality of communication devices being in wireless communication with said location module in said emergency vehicle, each communication device of said plurality of communication devices receiving said physical location of said emergency vehicle from said location module, each communication device of said plurality of communication devices broadcasting a notification alert when each communication device of said plurality of communication devices receives said physical location of said emergency vehicle from said location module wherein each communication device of said plurality of communication devices is configured to inform a driver of a respective vehicle to pull over such that said emergency vehicle can travel unimpeded to said physical location related to said emergency notification of said emergency.

2. The emergency vehicle alert device according to claim 1, wherein:
said emergency vehicle alert device includes a global positioning system;
said emergency vehicle alert device includes an emergency vehicle transceiver being integrated into said emergency vehicle;
said emergency vehicle transceiver defines said location module in said emergency vehicle;
said emergency vehicle transceiver is in wireless communication with said communication network;
said emergency vehicle transceiver is in wireless communication with said global positioning system; and
said emergency vehicle transceiver receives said response command from said communication network such that said emergency vehicle is notified of said physical location related to said emergency notification of said emergency.

3. The emergency vehicle alert device according to claim 2, wherein said emergency vehicle transceiver continuously broadcasts a tracking signal to said global positioning system when said emergency vehicle transceiver receives said response command from said communication network.

4. The emergency vehicle alert device according to claim 3, wherein said tracking signal comprises a physical location of said emergency vehicle as said emergency vehicle travels to said physical location related to said emergency notification of said emergency.

5. The emergency vehicle alert device according to claim 3, wherein:
each communication device of said plurality of communication devices includes a communication transceiver;
said communication transceiver in each communication device of said plurality of communication devices is in wireless communication with said global positioning system;
each communication device of said plurality of communication devices establishes a physical location of each communication device of said plurality of communication devices based upon data received from said global positioning system; and
said communication transceiver in each communication device of said plurality of communication devices receives said tracking signal from said global positioning system which was broadcast by said emergency vehicle transceiver.

6. The emergency vehicle alert device according to claim 5, wherein:
each communication device of said plurality of communication devices includes a mapping module;
said mapping module in a respective communication device of said plurality of communication devices is in electrical communication with said communication transceiver in said respective communication device.

7. The emergency vehicle alert device according to claim 6, wherein:
said mapping module in said respective communication device analyzes said tracking signal from said global positioning system which was broadcast by said emergency vehicle transceiver; and
said mapping module identifies a relationship between said physical location of said respective communication device and said physical location of said emergency vehicle.

8. The emergency vehicle alert device according to claim 7, wherein a respective communication device of said plurality of communication devices broadcasts said notification alert when said mapping module determines that said relationship between said physical location of said respective communication device of said plurality of communication devices involves said respective communication device being located on a route being taken by said emergency vehicle as said emergency vehicle travels to said physical location related to said emergency notification of said emergency wherein said respective communication device is configured to inform the driver of a respective vehicle to pull over such that said emergency vehicle can travel unimpeded to said physical location related to said emergency notification of said emergency.

9. An emergency vehicle alert device for alerting motorists on a route of an emergency vehicle to the impending presence of the emergency vehicle, said device comprising:
a communication network;
a global positioning system;
an emergency dispatch being in wireless communication with said communication network, said emergency dispatch receiving an emergency notification of an emergency from said communication network wherein said emergency dispatch is configured to receive a call for help from an occupant of a residence or a building regarding an emergency at the residence or the building, said emergency dispatch broadcasting an emergency alert to said communication network when said emergency dispatch receives said emergency notification of said emergency from said communication network, said emergency alert including a physical location related to said said emergency notification of said emergency, said communication network being extrinsic with respect to said emergency dispatch;
an emergency station being in wireless communication with said communication network, said emergency station receiving said emergency alert from communication network which was broadcast from said emergency dispatch, said emergency station broadcasting a response command when said emergency station receives said emergency alert from said communication network, said response command including said physical location related to said emergency notification of said emergency, said communication network being extrinsic with respect to said emergency station;
an emergency vehicle being located at said emergency station, said emergency vehicle being in wireless communication with said emergency station, said emergency vehicle receiving said response command from said emergency station such that said emergency vehicle is notified of said physical location related to said emergency notification of said emergency, said emergency vehicle including a location module which broadcasts a physical location of said emergency vehicle while said emergency vehicle travels to said physical location related to said emergency notification of said emergency;
an emergency vehicle transceiver being integrated into said emergency vehicle, said emergency vehicle transceiver defining said location module in said emergency vehicle, said emergency vehicle transceiver being in wireless communication with said communication network, said emergency vehicle transceiver receiving said response command from said communication network such that said emergency vehicle is notified of said physical location related to said emergency notification of said emergency, said emergency vehicle transceiver being in wireless communication with said global positioning system, said emergency vehicle transceiver continuously broadcasting a tracking signal to said global positioning system when said emergency vehicle transceiver receives said response command from said communication network, said tracking signal comprising a physical location of said emergency vehicle as said emergency vehicle travels to said physical location related to said emergency notification of said emergency;
a plurality of vehicles, each vehicle of said plurality of vehicles traveling on a public roadway;
a plurality of communication devices, each communication device of said plurality of communication devices being located within a respective vehicle of said plurality of vehicles, each communication device of said plurality of communication devices being in wireless communication with said location module in said emergency vehicle, each communication device of said plurality of communication devices receiving said physical location of said emergency vehicle from said location module, each communication device of said plurality of communication devices broadcasting a notification alert when each communication device of said plurality of communication devices receives said physical location of said emergency vehicle from said location module wherein each communication device of said plurality of communication devices is configured to inform a driver of a respective vehicle to pull over such that said emergency vehicle can travel unimpeded to said physical location related to said emergency notification of said emergency;
wherein each communication device of said plurality of communication devices includes a communication transceiver, said communication transceiver in each communication device of said plurality of communication devices being in wireless communication with said global positioning system, each communication device of said plurality of communication devices establishing a physical location of each communication device of said plurality of communication devices based upon data received from said global positioning system, said communication transceiver in each communication device of said plurality of communication devices receiving said tracking signal from said global positioning system which was broadcast by said emergency vehicle transceiver;
wherein each communication device of said plurality of communication devices includes an mapping module, said mapping module in a respective communication device of said plurality of communication devices being in electrical communication with said communication transceiver in said respective communication device, said mapping module in said respective communication device analyzing said tracking signal from said global positioning system which was broadcast by said emergency vehicle transceiver, said mapping module identifying a relationship between said physical location of said respective communication device and said physical location of said emergency vehicle, a respective communication device of said plurality of communication devices broadcasts said notification alert when said mapping module determines that said relationship between said physical location of said respective communication device of said plurality of communication devices involves said respective communication device being located on a route being taken by said emergency vehicle as said emergency vehicle travels to said physical location related to said emergency notification of said emergency wherein said respective communication device is configured to inform the driver of a respective vehicle to pull over such that said emergency vehicle can travel unimpeded to said physical location related to said emergency notification of said emergency.
